(19) United States
(12) Patent Application Publication
(10) Pub. No.: US 2025/0259015 A1
(43) Pub. Date: Aug. 14, 2025

(54) INFORMATION PROCESSING APPARATUS, CONTROL METHOD OF INFORMATION PROCESSING APPARATUS, AND NON-TRANSITORY COMPUTER-READABLE STORAGE MEDIUM

(71) Applicant: NEC Corporation, Tokyo (JP)

(72) Inventors: Masaki INOKUCHI, Tokyo (JP); Takayuki KURODA, Tokyo (JP); Masaharu MORIMOTO, Tokyo (JP)

(73) Assignee: NEC Corporation, Tokyo (JP)

(21) Appl. No.: 19/024,166

(22) Filed: Jan. 16, 2025

(30) Foreign Application Priority Data
Feb. 9, 2024 (JP) 2024-018327

(51) Int. Cl. G06F 40/40; G06N 3/0475

(52) U.S. Cl. CPC G06F 40/40; G06N 3/0475

(57) ABSTRACT

An information processing apparatus includes an acquiring means and a first generating means. The acquiring means acquires a first requirement information described in a natural language. The first generating means generates a prompt, the prompt for being input into a first language model, to extract at least one of a component, a function of the component, and information related to performance from the acquired first requirement information. The information processing apparatus may further include a verifying means that verifies validity of a second requirement information acquired by inputting the generated prompt into the first language model.

### INCORPORATION BY REFERENCE

This application is based upon and claims the benefit of priority from Japanese Patent Application No. 2024-18327, filed on Feb. 9, 2024, the disclosure of which is incorporated herein in its entirety by reference.

### TECHNICAL FIELD

The present invention relates to an information processing apparatus, a control method of an information processing apparatus, and a non-transitory computer-readable storage medium storing a program.

### BACKGROUND ART

There are technologies related to requirements (requirements definition) used in system design.

For example, Patent Literature 1 (JP2016-051234 A) describes that a system for describing and verifying requirement specification is provided, which makes it possible to suppress discrepancies in understanding by a designer and to verify necessity and sufficiency of lower-level requirement against upper-level requirement to prevent a contradiction and an omission of consideration of the requirement.

The system in Patent Literature 1 includes a requirement content input unit, a requirement structure input unit, and a requirement display unit. With respect to a requirement-related matter that indicates a requirement or tacit knowledge, the requirement content input unit inputs the requirement-related matter by expressing each of components of the requirement-related matter by a symbol and also by expressing a relationship of the components by a mathematical symbol.

The requirement structure input unit sets and inputs mutual relationships of a plurality of requirement related matters that are input from the requirement content input unit in a form that decomposes the relationship of the plurality of requirement related matters from a higher level to a lower level. The requirement display unit displays a relationship between the requirement related matter that is input in the requirement content input unit and the requirement related matter that is input in the requirement structure input unit.

In system development (system design) related to large-scale networks, and so on requirements definition is important. In particular, the requirements definition is important in the development of systems that are composed by combining a plurality of components in consideration of various requests, and so on for the system.

In system development, engineers may create the requirements definition using natural language, and organize components, functions of components, performance, and so on of a system by using the created requirements definition and language model (learning model acquired by machine learning).

However, even if the requirements definition described in natural language are input to the language model (querying the language model), appropriate results are often not acquired. Specifically, the requirements definition generated by the language model may include missing necessary information, added unnecessary information, or modifications that are not intended by the user. In particular, information (function, performance) that is not included in the training data used to generate the language model is often not processed correctly, leading to missing or altered information described above.

### SUMMARY

It is a main object of the present invention to provide an information processing apparatus, a control method of an information processing apparatus, and a program, which contribute to generating more accurate requirements definition using a language model.

According to a first aspect of the present invention, there is provided an information processing apparatus, including: an acquiring means that acquires a first requirement information described in a natural language; and a first generating means that generates a prompt, the prompt for being input into a first language model, to extract at least one of a component, a function of the component, and information related to performance from the acquired first requirement information.

According to a second aspect of the present invention, there is provided a control method of an information processing apparatus, the control method including: an acquiring step that acquires a first requirement information described in a natural language; and a first generating step that generates a prompt, the prompt for being input into a first language model, to extract at least one of a component, a function of the component, and information related to performance from the acquired first requirement information.

According to a third aspect of the present invention, there is provided a non-transitory computer-readable storage medium storing a program causing a computer to perform processing for: an acquiring processing that acquires a first requirement information described in a natural language; and a first generating processing that generates a prompt, the prompt for being input into a first language model, to extract at least one of a component, a function of the component, and information related to performance from the acquired first requirement information.

### BRIEF DESCRIPTION OF THE DRAWINGS

Exemplary features and advantages of the present invention will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an example embodiment of the present disclosure;

FIG. 4 is a diagram illustrating an example of a processing configuration of an assistance apparatus according to the example embodiment of the present disclosure;

FIG. 5 is a diagram illustrating an example of template information according to the example embodiment of the present disclosure;

FIG. 6 is a diagram illustrating an example of component information according to the example embodiment of the present disclosure;

FIG. 7 is a flowchart illustrating an example of an operation of a system requirement control unit according to the example embodiment of the present disclosure;

FIG. 8 is a diagram illustrating an example of a prompt according to the example embodiment of the present disclosure;

FIG. 9 is a diagram illustrating an example of a display of a terminal according to the example embodiment of the present disclosure;

FIG. 10 is a diagram illustrating an example of a processing configuration of the assistance apparatus according to the example embodiment of the present disclosure;

FIG. 11 is a diagram illustrating an example of information for verification according to the example embodiment of the present disclosure;

FIG. 12 is a diagram illustrating an example of a display of the terminal according to the example embodiment of the present disclosure;

FIG. 13 is a diagram illustrating an example of a display of the terminal according to the example embodiment of the present disclosure;

FIG. 14 is a diagram illustrating an example of a display of the terminal according to the example embodiment of the present disclosure;

FIG. 15 is a diagram illustrating an example of a display of the terminal according to the example embodiment of the present disclosure;

FIG. 16 is a diagram illustrating an example of a display of the terminal according to the example embodiment of the present disclosure;

FIG. 17 is a diagram illustrating an example of a display of the terminal according to the example embodiment of the present disclosure;

FIG. 18 is a diagram illustrating an example of a processing configuration of the assistance apparatus according to the example embodiment of the present disclosure;

FIG. 19 is a diagram illustrating an example of sentence example information according to the example embodiment of the present disclosure;

FIG. 20 is a diagram illustrating an example of instruction information according to the example embodiment of the present disclosure;

FIG. 21 is a diagram illustrating an example of the prompt according to the example embodiment of the present disclosure;

FIG. 22 is a diagram illustrating an example of a processing configuration of the assistance apparatus according to the example embodiment of the present disclosure;

FIG. 23 is a diagram illustrating an example of a display of the terminal according to the example embodiment of the present disclosure; and

FIG. 24 is a diagram illustrating an example of a hardware configuration of the assistance apparatus of the present disclosure.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

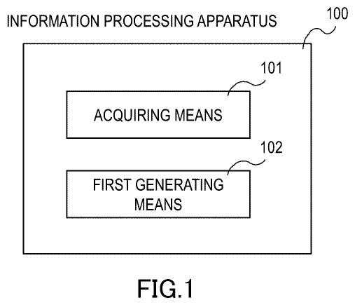

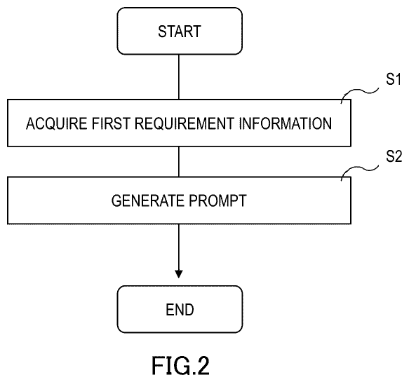

An information processing apparatus 100 according to an example embodiment includes an acquiring means 101 and a first generating means 102 (see FIG. 1). The acquiring means 101 acquires a first requirement information described in a natural language (step S1 in FIG. 2). The first generating means 102 generates a prompt, the prompt for being input into a first language model, to extract at least one of a component, a function of component, and information related to performance from the acquired first requirement information (step S2).

The information processing apparatus 100 generates a prompt that includes an instruction to extract at least one of a component, a function of component, and performance included in requirement information acquired from a user, and inputs the generated prompt into a language model. More specifically, the information processing apparatus 100 generates the prompt that includes the component that needs to be extracted from the requirement information, information related to the function of the component and the performance of the component. The language model directed by such a prompt can accurately extract the function and performance from the requirement information input by the user. As a result, the information processing apparatus 100 can acquire more accurate and appropriate requirement definition with less possibility of lacking necessary information, adding unnecessary information, or having modifications unintended by the user.

Hereinafter, specific example embodiments will be described in more detail with reference to drawings.

### First Example Embodiment

A first example embodiment will be described in more detail with reference to drawings.

### System Configuration

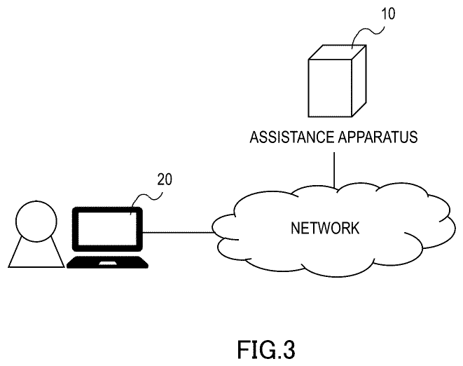

As shown in FIG. 3, an information processing system according to the first example embodiment includes an assistance apparatus 10 and a terminal 20.

The assistance apparatus 10 is the information processing apparatus that assists a system design by a user. For example, the assistance apparatus 10 is a server installed on a network (on a cloud).

The assistance apparatus 10 acquires a requirement (information related to requirement; requirement information) for a system that the user is targeting for design. More specifically, the assistance apparatus 10 acquires the requirement information described in a natural language (system requirement described using plain sentences).

The assistance apparatus 10 extracts at least one of a component of the system, a function of component, and information related to performance from the acquired requirement information. The assistance apparatus 10 generates a system requirement (requirement information) that includes the component, function of component, and information related to performance extracted from the requirement information input by the user.

More specifically, the assistance apparatus 10 extracts the component included in the system requirement acquired from the user, and generates the system requirement as an itemized list of the function and performance of each of the extracted component. The components that include the system can include hardware and software.

For example, the assistance apparatus 10 acquire requirement information such as “A live video distribution system that enables 10,000 people to watch simultaneously. The system uses AI application X1 to recognize human faces and display their names. The system shall ensure communication quality of 10 Mbps or higher.”

The assistance apparatus 10 generates requirement information such as: “Simultaneous use by 10,000 people. Recognizes faces. Ensures communication quality of 10 Mbps or higher. Utilizes AI application X1.” from the requirement information.

Note that, in the following description, the system requirement acquired by the assistance apparatus 10 (the requirement information input by the user) will be described as an “input system requirement”. Furthermore, the system requirement generated by extracting a component, a function of component, and information related to performance from the input system requirement will be described as “generated system requirement.” The assistance apparatus 10 acquires the input system requirement and generates the generated system requirement from the input system requirement.

The assistance apparatus 10 uses a learning model at the timing of generating the generated system requirement. More specifically, the assistance apparatus 10 outputs a new system requirement generated from the input system requirement input by the user using the language model such as a large language model (LLM; Large Language Model).

The user operates a terminal 20 to access the assistance apparatus 10. The user inputs various information into the assistance apparatus 10 or acquires various information from the assistance apparatus 10.

Note that the configuration of the information processing system shown in FIG. 3 is an example and is not intended to limit the configuration. For example, the information processing system may include a plurality of assistance apparatuses 10. Load distribution and redundancy may be achieved by a plurality of assistance apparatuses 10.

### Outline of Operation

Next, an outline of operation of the assistance apparatus 10 with respect to the generated system requirement will be described.

As described above, the assistance apparatus 10 acquires the input system requirement (requirement information described in a natural language) from the terminal 20 of the user. The assistance apparatus 10 uses the acquired input system requirement to generate a prompt (query) to be input to the language model. The assistance apparatus 10 generates the prompt to be input into the language model and the prompt to extract at least one of a component, a function of component, and information related to performance, from the input system requirement.

At that time, the assistance apparatus 10 generates the prompt using “template information” and “component information.”

The template information is information that includes an instruction to the language model, and so on. For example, a statement such as “Please perform requirement definition for system development.” corresponds to the template information. As a rule, a fixed phrase is used for the template information.

The component information consists of a component name that can be used in system design, function information related to configuration, and performance information. The component information defines the function and performance of the component (hardware and/or software) that consists of the system. For example, taking the component “camera” as an example, in the component requirement information, “capturing a photo or video” is defined as a function of the camera, and “number of pixels and internal storage capacity” is defined as a performance indicator of the camera.

The component information is created by an engineer or the like who is familiar with the target system. The engineer generates the component information by envisioning the component, the function and the performance necessary to generate the generated system requirement.

Once the assistance apparatus 10 acquires the input system requirement (requirement information) from the user, the assistance apparatus 10 generates a prompt to be input into the language model using the template information and component information. The assistance apparatus 10 generates the prompt composed of the template information, component information, and the input system requirement.

The assistance apparatus 10 acquires the generated system requirement by inputting the generated prompt into the language model. The assistance apparatus 10 presents the acquired generated system requirement to the user.

Next, details of the assistance apparatus 10 according to the first example embodiment will be described.

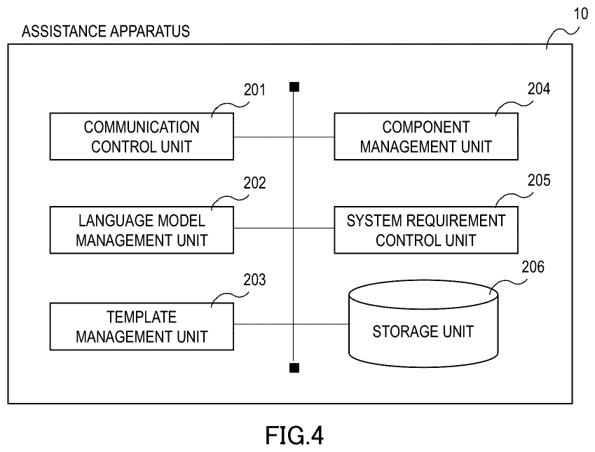

FIG. 4 is a diagram illustrating an example of a processing configuration (processing module) of the assistance apparatus 10 according to the example embodiment of the present application. Referring to FIG. 4, the assistance apparatus 10 includes a communication control unit 201, a language model management unit 202, a template management unit 203, a component management unit 204, a system requirement control unit 205, and a storage unit 206.

The communication control unit 201 is means for controlling communication with other apparatuses. For example, the communication control unit 201 receives data (packets) from the terminal 20. In addition, the communication control unit 201 transmits data to the terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The language model management unit 202 is means for performing control and management related to the language model used for acquiring the generated system requirement.

As an example, the language model may be, but is not limited to, what is referred to as a large-scale language model, for example.

The language model is a machine learning model (also called a generative model) that inputs language and outputs language. The language model is a model that has been trained on a relationship between words in a sentence and generates a related character string related to the target character string from the target character string. By using the language model that has been trained on sentences and sentences in various contexts, it is possible to generate the related character string with an appropriate content related to the target character string.

Once a prompt is generated based on an input system request or the like is input, the language model outputs an answer corresponding to the prompt.

The training method of the language model is not particularly limited, but as an example, the language model may be trained to output at least one sentence that includes an input character string. To take a specific example, the language model is a GPT (Generative Pre-Transformer) that outputs a sentence that includes the input character string by predicting a character string that is more likely to follow the input string.

Other language models include, for example, T5 (Text-to-Text Transfer Transformer), BERT (Bidirectional Encoder Representations from Transformers), RoBERTa (Robustly optimized BERT approach), ELECTRA (Efficiently Learning an Encoder that Classifies Token Replacements Accurately), and so on are also language models.

A system administrator or the like prepares the language model to be implemented in the assistance apparatus 10 using a vast amount of design documents, specifications, and so on related to the system design.

The language model management unit 202 acquires the language model (the language model generated by training using training data) prepared by the system administrator or the like. For example, the language model management unit 202 acquires the language model using a GUI (Graphical User Interface) or the like. Alternatively, the language model management unit 202 may acquire the language model via a USB (Universal Serial Bus) memory, or the like.

Alternatively, the language model management unit 202 may perform machine learning using the training data and generate the language model.

The language model management unit 202 stores the acquired language model in the storage unit 206.

The template management unit 203 is means for performing control and management related to template information. The template management unit 203 acquires the template information used to generate a prompt to be input into the language model from the system administrator or the like.

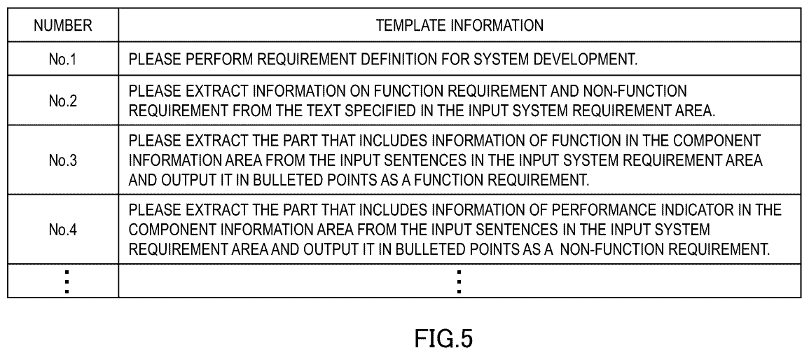

For example, the template management unit 203 acquires the template information using a GUI, a USB memory, or the like. The template management unit 203 stores the acquired template information in the storage unit 206. For example, the template management unit 203 stores the template information as described in FIG. 5 in the storage unit 206.

The component management unit 204 is means for performing control and management related to component information. The component management unit 204 acquires component information used to generate a prompt to be input into the language model from the system administrator, or the like.

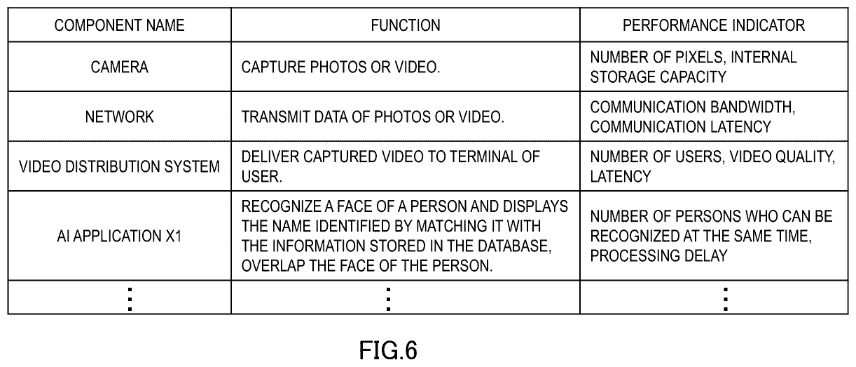

For example, the component management unit 204 acquires the component information using a GUI, a USB memory, or the like. The component management unit 204 stores the acquired component information in the storage unit 206. For example, the template management unit 203 stores the component information as described in FIG. 6 in the storage unit 206.

The system requirement control unit 205 is means for performing control for generating a generated system requirement from an input system requirement.

The system requirement control unit 205 includes a function as an acquiring unit and a function as a first generating means. The system requirement control unit 205 as the acquiring unit acquires first requirement information described in a natural language. The system requirement control unit 205 as the first generating means generates a prompt to be input into a first language model and the prompt to extract a function of component, or information related to performance from the acquired first requirement information.

In other words, the system requirement control unit 205 generates prompts that include instructions to extract function information and performance information for each component from the input information (the system requirement input to the assistance apparatus 10 by the user).

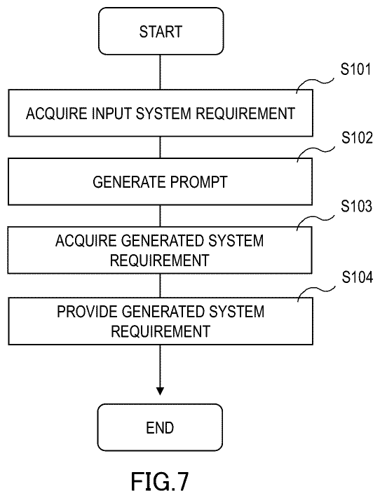

FIG. 7 is a flowchart illustrating an example of an operation of the system requirement control unit 205 according to an example embodiment of the present application. Referring to FIG. 7, the operation of the system requirement control unit 205 will be described.

The system requirement control unit 205 acquires an input system requirement from a user (the terminal 20 of a user) who has accessed the assistance apparatus 10 (step S101). For example, the system requirement control unit 205 acquires the input system requirement using a GUI or the like.

The system requirement control unit 205 generates a prompt to be input into the language model using the acquired input system requirement, template information, and component information (step S102).

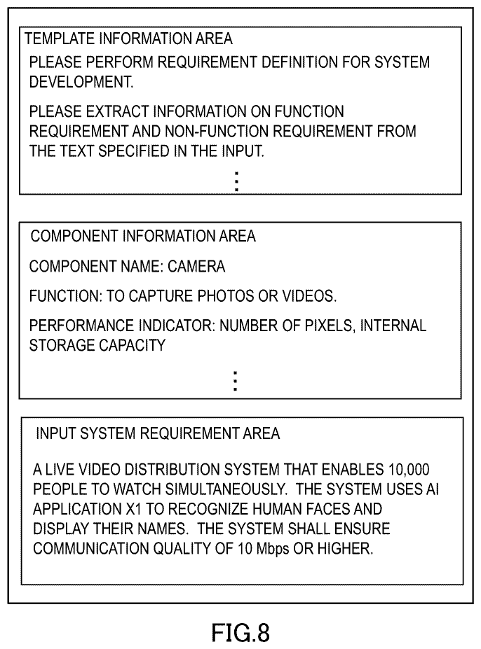

At that time, the system requirement control unit 205 generates the prompt that include three areas. Specifically, the system requirement control unit 205 generates the prompt that includes a template information area, a component information area, and an input system requirement area. For example, the system requirement control unit 205 generates the prompt shown in FIG. 8 In FIG. 8, the top row corresponds to the template information area, the middle row corresponds to the component information area, and the bottom row corresponds to the input system requirement area.

The system requirement control unit 205 duplicates the template information stored in the storage unit 206 in the template information area. The system requirement control unit 205 duplicates the component information stored in the storage unit 206 in the component information area. The system requirement control unit 205 duplicates the input system requirement acquired from the user in the input system requirement area.

The system requirement control unit 205 generates the prompt to be input into the language model by setting information corresponding to each of the three areas. The system requirement control unit 205 acquires an answer (generated system requirement) from the language model by inputting the generated prompt into the language model (step S103).

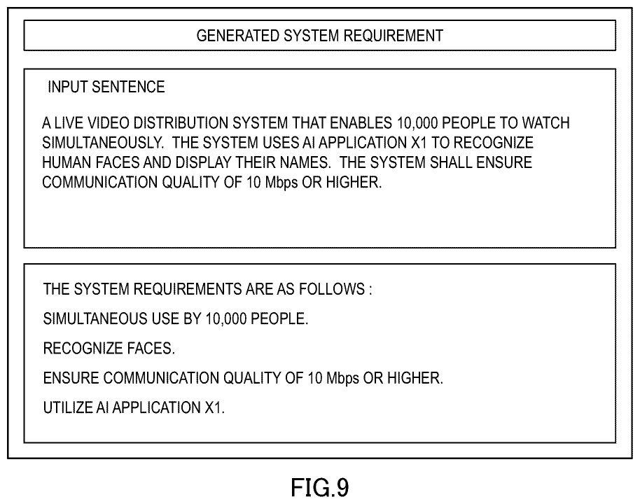

The system requirement control unit 205 provides the acquired generated system requirement to the user (step S104). For example, the system requirement control unit 205 displays a screen on the terminal 20 as shown in FIG. 9.

In this way, the system requirement control unit 205 generates the instruction (prompt) for the language model by combining the template information and the component information, and extracts the component, the function of component, and the performance indicator from the requirement information input by the user. For example, function information (information related to function) is extracted as a “function requirement” from the system requirement that the user has input by a prompt including the template information of No. 3 shown in FIG. 5 and the component information shown in FIG. 6. In addition, the performance indicator (information related to performance) is extracted as a “non-function requirement” from the system requirement that the user has input by a prompt including the template information of No. 4 shown in FIG. 5 and the component information shown in FIG. 6.

The storage unit 206 is means for storing information necessary for an operation of the assistance apparatus 10.

### Terminal

A detailed description of the terminal 20 will be omitted. Examples of the terminal 20 include a portable terminal device such as a smartphone, a portable phone, a game console, or a tablet and a computer (a personal computer or a laptop computer). The terminal 20 can be any equipment or device as long as the terminal 20 can accept an operation by a user and can communicate with the assistance apparatus 10.

As described above, the assistance apparatus 10 of the first example embodiment retains the information related to the component (component name, function information, and performance information) necessary for the requirement definition as the component information, and generates a prompt to be input into the language model using the component information. By inputting the prompt generated using the requirement information and the component information input by the user into the language model, the assistance apparatus 10 extracts the component, function, and performance information related to performance included in the requirement information, and generates a new requirement definition. In other words, by generating an appropriate prompt using the component information, and so on, the assistance apparatus 10 can generate a more appropriate requirement definition (a more useful requirement definition) in which there is no missing necessary information, no unnecessary information added, no modification, and so on unintended by the user.

Here, a clear and concrete instruction (prompt) is necessary for the language model to output an appropriate response (result) to a request or inquiry of the user. The assistance apparatus 10 can acquire a more precise and accurate requirement definition by generating the clear and specific instruction by using the template information and component information, and inputting the generated clear and concrete instruction into the language model.

### Second Example Embodiment

Next, a second example embodiment will be described in detail with reference to drawings.

The assistance apparatus 10 according to the second example embodiment retains information related to a relationship among the components and among the performance indicators. The assistance apparatus 10 verifies the generated system requirement using the information. More specifically, the assistance apparatus 10 detects a deficiency (defect), and so on of the generated system requirement that needs to be modified, and so on, by verifying validity of the generated system requirement.

For example, the assistance apparatus 10 detects a contradiction in the generated system requirement, a conflict among components, a conflict among performance indicators, or a lack of information, and so on. The assistance apparatus 10 requests the user to check the detected deficiency and accepts a modification of the generated system requirement by the user.

As the information processing system according to the second example embodiment can have the same configuration as that according to the first example embodiment, the description corresponding to FIG. 3 will be omitted.

The following description will be made with a focus on the difference between the first example embodiment and the second example embodiment.

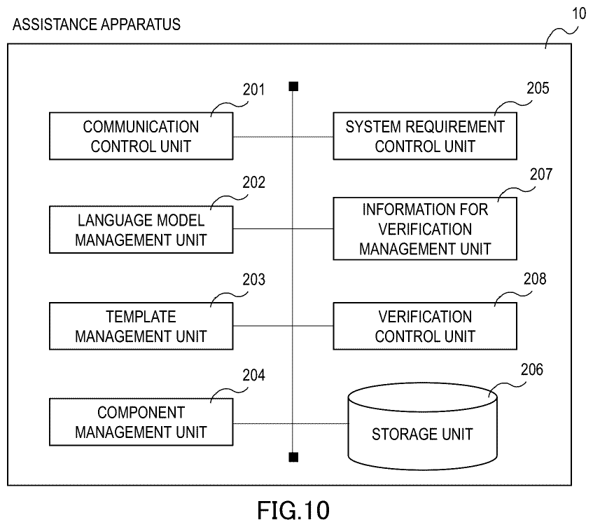

FIG. 10 is a diagram illustrating an example of a processing configuration (processing module) of the assistance apparatus 10 according to an example embodiment of the present application. Referring to FIG. 10, an information for verification management unit 207 and a verification control unit 208 are added to the configuration of the assistance apparatus 10 according to the first example embodiment.

The information for verification management unit 207 is means for performing control and management for information related for verification (hereinafter referred to as “information for verification”) used in verifying the validity of the generated system requirement.

The system administrator, or the like registers information for verification in the assistance apparatus 10. The assistance apparatus 10 verifies the validity of the generated system requirement by using the information for verification to detect an item that could be added to the generated system requirement or to detect an item that causes a contradiction or conflict in the generated system requirement.

Examples of items that can be added to the generated system requirement include the performance indicator that is not explicitly stated in the generated system requirement, a concrete component that corresponds to an abstract component included in the requirement, or the component that is expected from the component included in the requirement, and so on.

Examples of items that cause a contradiction or conflict in the generated system requirement include a combination of the component that cannot be used simultaneously, a combination of the performance indicator that has a trade-off relationship, and so on.

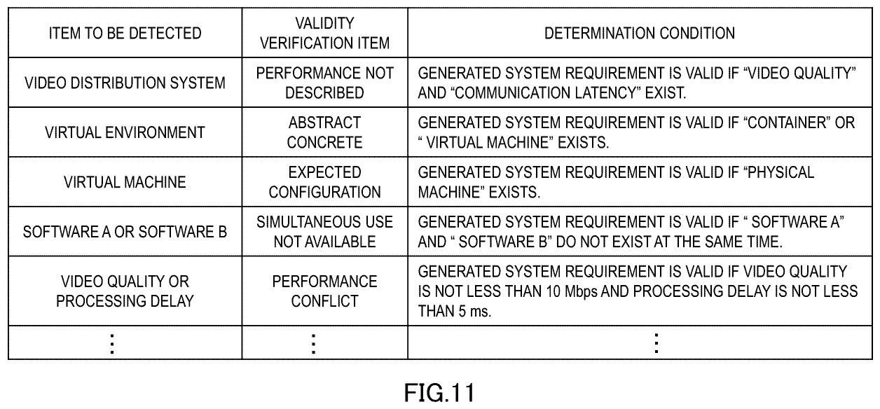

The information for verification consists of items such as an item to be detected, a validity verification item, and a determination condition (see FIG. 11).

The item to be detected is information related to the component and performance indicator to be detected from the generated system requirement. For example, in FIG. 11, the components such as “video distribution system” or “virtual environment” and the performance indicator such as “video quality” or “processing delay” are listed as the items to be detected.

The validity verification item is information related to a viewpoint (perspective) for performing validity verification of the item to be detected. For example, in FIG. 11, the validity verification items such as “performance not described”, “abstract concrete,” “expected configuration,” “simultaneous use not available,” and “performance conflict” are listed.

The determination condition is the condition for determining the generated system requirement including the item to be detected as “valid” in the case where the case where the item to be detected is included in the generated system requirement.

The validity verification item “performance not described” indicates that the validity of the generated system requirement is verified from the viewpoint of presence or absence of the performance indicator required for the item to be verified described in the generated system requirement. For example, in the example of the first line of FIG. 11, in the case where “video distribution system” is detected as the item to be detected, the presence or absence of the performance indicator such as “video quality” and “communication delay” is determined. If there is a description with respect to the “video quality” and “communication delay” in the generated system requirement related to the video distribution system, the generated system requirement is determined to be “valid.” In other words, if there is no mention of the “video quality” and “communication delay” in the generated system requirement related to the video distribution system, the generated system requirement is determined to be “invalid.”

The validity verification item “abstract concrete” indicates that the validity of the generated system requirement is verified from the viewpoint of the presence or absence of the concrete component that is required to be described in the generated system requirement corresponding to the abstract component included in the generated system requirement. For example, in the example of the second line of FIG. 11, “virtual environment” is detected as the item to be detected, and in the case where the generated system requirement includes the component “container” or “virtual machine,” the generated system requirement is determined to be valid. In other words, the generated system requirement that lacks the “container” or “virtual machine,” which is concrete means for realizing the “virtual environment,” is determined to be invalid.

The validity verification item “expected configuration” indicates that the validity of the generated system requirement is verified from the viewpoint of the presence or absence of other components expected from the components included in the generated system requirement. For example, in the example of the third line of FIG. 11, in the case where “virtual machine” is detected as the item to be detected and “physical machine” is included in the generated system requirement, the generated system requirement is determined to be valid. In other words, the generated system requirement that lacks the “physical machine,” which is essential for the realization of the “virtual machine,” is determined to be “invalid.”

The validity verification item “simultaneous use not available” indicates that the validity of the generated system requirement is verified from the viewpoint of the presence or absence of a combination of the components that cannot be used simultaneously. For example, in the example of the fourth line of FIG. 11, if “Software A” and “Software B” are not described in the same generated system requirement, the generated system requirement is determined to be valid. In other words, if Software A and Software B are described in the same generated system requirement, the generated system requirement is determined to be “invalid (or inappropriate)”.

The validity verification item “performance conflict” indicates that the validity of the generated system requirement is verified from the viewpoint of the presence or absence of a combination of the performance indicators that are in a trade-off relationship. For example, in the example of the fifth line of FIG. 11, it is defined that the “video quality” and “processing delay” are in a trade-off relationship, and the condition to achieve both of these performances is described in the determination condition. It should be noted that although not shown in FIG. 11, there can also be the conflict (trade-off) between “cost” and “performance.”

The engineer or the like generates the information for verification which are essential for the system design, and so on, while assuming the item to be detected, and so on. The system administrator, or the like, inputs the generated information for verification into the assistance apparatus 10.

The information for verification management unit 207 stores the acquired information for verification in the storage unit 206. For example, the information for verification management unit 207 stores the table information shown in FIG. 11 in the storage unit 206 as the information for verification.

The verification control unit 208 is means for performing control related to the verification of the generated system requirement generated from the input system requirement (input sentences by the user). More specifically, the verification control unit 208 verifies the validity of generated system requirement (requirement information) acquired by inputting a prompt generated based on component information, and so on, into the language model.

The verification control unit 208 acquires the generated system requirement from the system requirement control unit 205. The verification control unit 208 attempts to detect each of the items to be detected described in the information for verification from the generated system requirement. Once the item to be detected is detected from the generated system requirement, the verification control unit 208 determines the validity of the generated system requirement using the corresponding determination condition.

In the example of the first line of FIG. 11, in the case where “video distribution system” is detected in the generated system requirement, if “video quality” or “communication delay” is described in the same generated system requirement, the generated system requirement is determined to be valid with respect to the item to be verified in the first line. On the other hand, if at least one of “video quality” and “communication delay” is not described in the generated system requirement, the generated system requirement with respect to the item to be verified “video distribution system” in the first line is determined to be invalid.

In the case where the generated system requirement is determined to be “invalid,” the verification control unit 208 requests the user to check this fact and make any modifications as necessary. At that time, the verification control unit 208 requests the user to check and modify as described above using an interface that corresponds to the item to be verified that has been determined to be invalid, the corresponding validity verification item (relationship among the components, relationship among the performance indicators), and the determination condition.

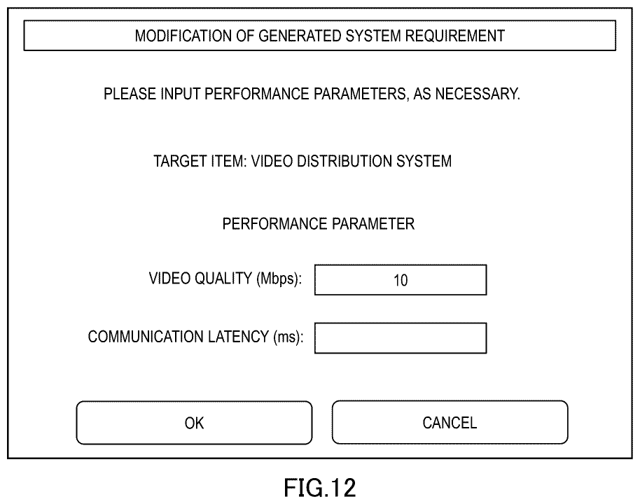

For example, in the case where the generated system requirement is determined to be invalid due to “performance not described” with respect to the item to be verified “video distribution system,” the verification control unit 208 displays an interface screen shown in FIG. 12 on the terminal 20. In the case where the “video distribution system” is detected but the required performance indicator “communication delay” is not included in the generated system requirement, the verification control unit 208 requests the user to check this fact and make any necessary modifications using an interface as shown in FIG. 12. Note that the verification control unit 208 acquires the performance indicator requested for the video distribution system using the information included in the determination condition.

In the case where the generated system requirement is determined to be invalid due to the “performance not described” factor, the verification control unit 208 presents the performance parameter information related to the components included in the generated system requirement to the user. Furthermore, the verification control unit 208 prompts the input performance parameter information corresponding to the component included in the generated system requirement.

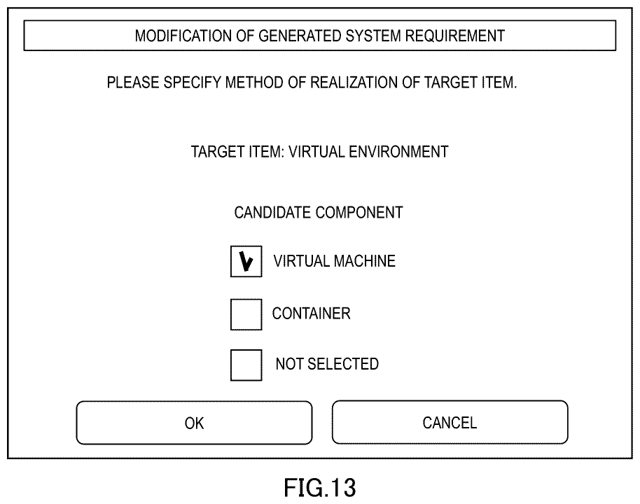

Alternatively, in the case where the generated system requirement is determined to be invalid due to the “abstract concrete” with respect to the item to be verified “virtual environment,” the verification control unit 208 displays an interface screen as shown in FIG. 13 on the terminal 20. In the case where the “virtual environment” has been detected but the component necessary to make the virtual environment concrete is not included in the generated system requirement, the verification control unit 208 uses an interface shown in FIG. 13 to request the user to check this fact and make any necessary modifications. The verification control unit 208 acquires the component to realize the abstract component from the determination condition and requests the user to add the acquired component. Note that in the case where the factor that has been determined to be invalid is related to “abstract concrete,” the verification control unit 208 may present the user with an option that does not dare to reveal any concrete components, as shown in FIG. 13.

In the case where the generated system requirement is determined to be invalid due to the “abstract concrete” factor, the verification control unit 208 presents the user with a candidate component to embody the component included in the generated system requirement. That is, the verification control unit 208 accepts an input with respect to selecting a component (part) that concretizes the component included in the generated system requirement. Note that the verification control unit 208 may present the user with an option to indicate that no additional information related to the component requirement is to be input.

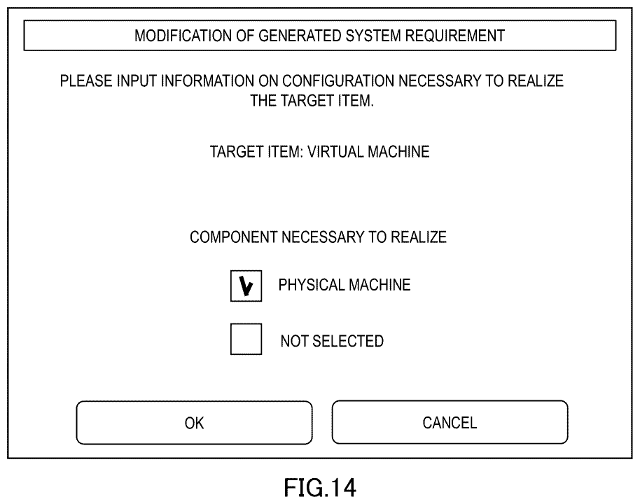

Alternatively, in the case where the generated system requirement is determined to be invalid due to the “expected configuration” with respect to the item to be verified, “virtual machine,” the verification control unit 208 displays an interface screen shown in FIG. 14 on the terminal 20. In the case where the “virtual machine” has been detected but another component necessary to run the virtual machine is not included in the generated system requirement, the verification control unit 208 requests the user to check this fact and make any necessary modifications using an interface shown in FIG. 14. The verification control unit 208 acquires other component expected from one component from the determination condition and requests the user to add the acquired component. Note that even in the case where the factor determined to be invalid is related to the “expected configuration,” the verification control unit 208 may present the user with an option that does not dare to reveal any concrete components, as shown in FIG. 14.

As described above, in the case where the system requirement is determined to be not valid due to the relationships among the components or among the performance indicators being the “performance not described,” “abstract concrete,” and “expected configuration,” the verification control unit 208 detects an element that can be added to the system requirement. That is, the verification control unit 208 verifies the validity of the generated system requirement information based at least on the relationship among the components or on the information related to the performance indicator, which is included in the generated system requirement (second requirement information). In the case where the generated system requirement is determined to be invalid, the verification control unit 208 detects the element (component, performance indicator) that can be added to the generated system requirement.

In addition, the verification control unit 208 provides an interface that enables the user to identify the element that can be added and/or an interface that enables the user to input additional information related to the element that can be added (see FIGS. 12 to 14). Note that FIG. 12, and so on, are drawings in which the interface that enables the user to identify the element that can be added and/or the interface that enables the user to input additional information related to the element that can be added are provided at the same time. However, either one of these interfaces may be provided to the user.

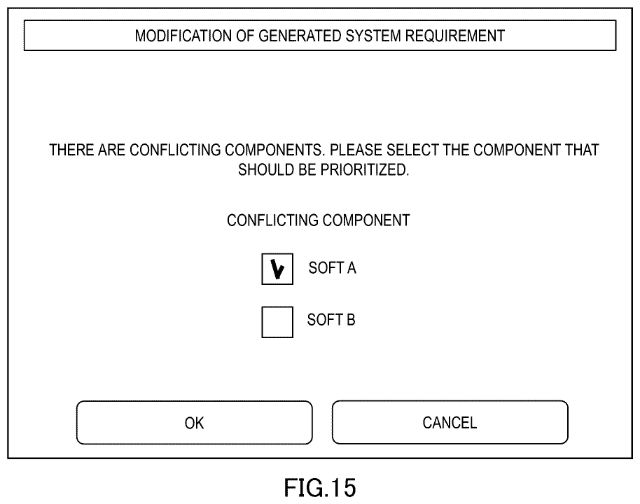

In the case where the generated system requirement is determined to be “invalid” due to “simultaneous use not available” with respect to the item to be verified “Software A” or the item to be verified “Software B,” the verification control unit 208 displays an interface screen as shown in FIG. 15 on the terminal 20. In the case where the generated system requirement is determined to be “invalid” due to “simultaneous use not available,” the verification control unit 208 requests the user to select one of the components to be used simultaneously using the interface as shown in FIG. 15.

In the case where the generated system requirement is determined to be invalid due to “simultaneous use not available,” the verification control unit 208 presents a conflicting component to the user. In addition, the verification control unit 208 accepts an input with regard to whichever of the conflicting components (parts) should be prioritized.

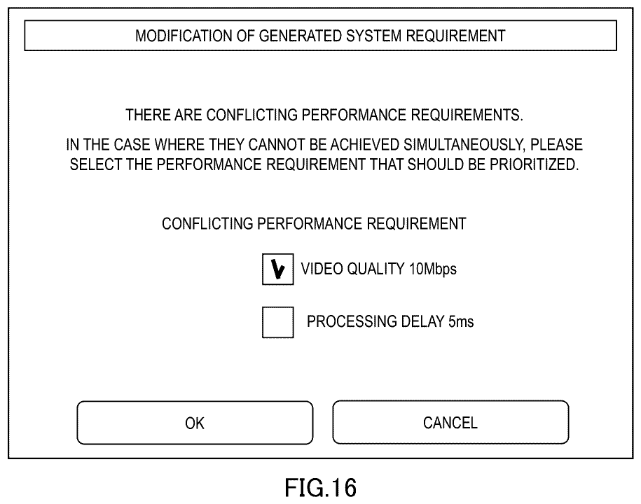

Alternatively, in the case where the generated system requirement is determined to be invalid due to the “performance conflict” with respect to the item to be verified “video quality” or the item to be verified “processing delay,” the verification control unit 208 displays an interface screen as shown in FIG. 16 on the terminal 20. In the case where the generated system requirement is determined to be “invalid” due to the “performance conflict,” the verification control unit 208 requests the user to select a prioritized performance indicator using an interface as shown in FIG. 16.

In the case where the generated system requirement is determined to be invalid due to the “performance conflict,” the verification control unit 208 presents the performance requirement in a trade-off relationship to the user. Furthermore, the verification control unit 208 accepts an input with respect to whichever of the performance requirements in the trade-off relationship is to be adopted in preference or not.

As described above, in the case where the system requirement is determined to be invalid due to the relationship among the components or among the performance indicators being “simultaneous use not available” and “performance conflict,” the verification control unit 208 detects a plurality of components or a plurality of performance indicators in the case where there is a conflict. That is, the verification control unit 208 verifies the validity of the generated system requirement based at least on the relationship among the components or on the information related to the performance indicator that is included in the generated system requirement (second requirement information). If the generated system requirement is determined to be invalid, the verification control unit 208 detects the plurality of conflicting components or the plurality of conflicting performance indicators in the generated system requirement.

The verification control unit 208 provides an interface that enables the user to identify the plurality of conflicting components or the plurality of conflicting performance indicators, and/or an interface that enables the user to input the component or the performance indicator that the user prioritizes from among the plurality of conflicting components or the performance indicators. Note that FIGS. 15 and 16 are drawings in which the interface that enables the user to identify the conflicting component, and so on, and the interface that enables the user to input the component, and so on, to be prioritized from the conflicting components, and so on, are provided at the same time. However, either one of these interfaces may be provided to the user.

The interface screens shown in FIGS. 12 through 16 are examples, and the interface for requesting the user to check and modify the generated system requirement determined to be invalid is not limited to the interface screens shown in FIG. 12, and so on.

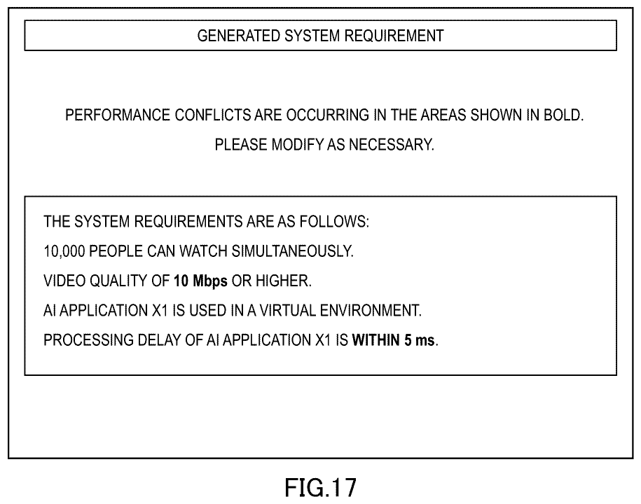

For example, in the case where the generated system requirement is determined to be invalid due to the “performance conflict” with respect to the item to be verified “video quality” or the item to be verified “processing delay,” the verification control unit 208 may display an interface screen as shown in FIG. 17 on the terminal 20. The verification control unit 208 may present the component or performance indicator that caused the determination to be invalid to the user by clearly indicating the component or performance indicator in a manner that is distinguishable from other components. For example, in FIG. 17, the performance indicators (specific numerical values of performance indicators) where the performance conflicts occur are displayed in bold.

Note that the method of clarifying the component by the verification control unit 208 is not limited to displaying the relevant component or performance indicator in bold. For example, the verification control unit 208 may clearly indicate a factor (component, performance indicator, and so on) determined to be invalid by changing the color, underlining, displaying a line number, and so on. Alternatively, the verification control unit 208 may display a pop-up or the like to modify the generated system requirement that has been determined to be invalid once the user places a cursor or the like over the factor (component, performance indicator, and so on) that has been determined to be invalid.

In this way, the verification control unit 208 may display the factor determined to be invalid by the verification of the generated system requirement, and may present an interface screen to the user that clearly indicates where information is lacking or where there are any performance conflicts, and so on.

As described above, the assistance apparatus 10 according to the second example embodiment retains the information on the relationship among the components (information for verification). The assistance apparatus 10 uses the information for verification and determines whether there are any contradictions, conflicts, and so on in the requirement information generated from the requirement information acquired from the user. If there are any contradictions, conflicts, or other deficiencies in the generated requirement information, the assistance apparatus 10 requests the user to confirm the deficiencies and accepts any necessary modifications. As a result, the assistance apparatus 10 can provide the user with a more appropriate requirement definition (system requirement).

### Third Example Embodiment

Next, a third example embodiment will be described in detail with reference to drawings.

The first example embodiment describes a case where the prompt to be input into the language model is generated by using the input system requirement acquired from the user as it is. Here, the input system requirement that the user inputs may include a sentence described with a complex structure. It may be difficult to acquire a more accurate generated system requirement in the case of the prompt generated using such an input system requirement.

Therefore, in the third example embodiment, the assistance apparatus 10 will describe a case where the assistance apparatus 10 converts the input system requirement acquired from the user into a format suitable for the language model. More specifically, the assistance apparatus 10 according to the third example embodiment retains sentence example information that paraphrases (converts) a complex sentence into a simple sentence. The assistance apparatus 10 generates the prompt to be input into the language model using the input system requirement converted using the sentence example information.

As the information processing system according to the third example embodiment can have the same configuration as that according to the first example embodiment, the description corresponding to FIG. 3 will be omitted.

The following description will be made with a focus on the difference from the first example embodiment to the third example embodiment.

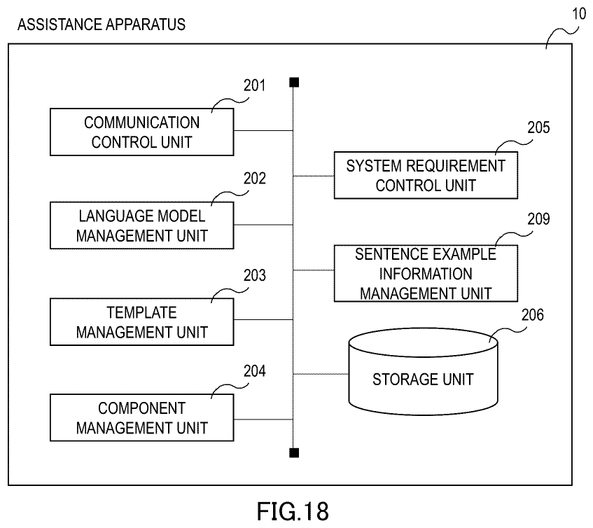

FIG. 18 is a diagram illustrating an example of a processing configuration (processing modules) of the assistance apparatus 10 according to an example embodiment of the present application. Referring to FIG. 18, a sentence example information management unit 209 is added to the configuration of the assistance apparatus 10 according to the first example embodiment.

The sentence example information management unit 209 is means for performing control and management related to sentence example information for converting the input system requirement.

The system administrator, or the like, generates the sentence example information in order to acquire a more accurate generated system requirement. For example, the system administrator, or the like, generates a sentence example that converts an input sentence to a predetermined and fixed format, a sentence example that converts an input sentence to a list of bullet points, a sentence example that converts an input sentence from a complex structure to a simple structure, and so on.

The system administrator, or the like, inputs the generated sentence example information into the assistance apparatus 10.

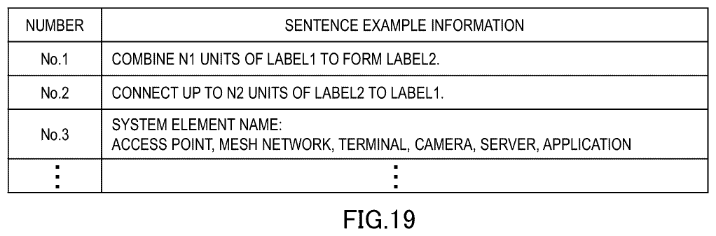

For example, the sentence example information management unit 209 acquires the sentence example information as shown in FIG. 19. The sentence example information management unit 209 stores the acquired sentence example information in the storage unit 206.

Here, the input system requirement is converted into the input system requirement with a more appropriate sentence using a language model. Note that the language model is different from the language model used to acquire the generated system requirement from the input system requirement.

In the following description, the language model for converting the input system requirement is denoted as “language model for conversion” and the language model for acquiring the generated system requirement is denoted as “language model for generating requirement”.

The language model management unit 202 according to the second example embodiment acquires the language model for conversion from the system administrator, or the like, and stores the language model for conversion in the storage unit 206.

In addition, the system administrator, or the like, generates instruction information that conforms to the generated sentence example information. The instruction information is used to generate the prompt to be input into the language model for conversion. The instruction information is information for providing an instruction related to utilizing the sentence example information to the language model for conversion.

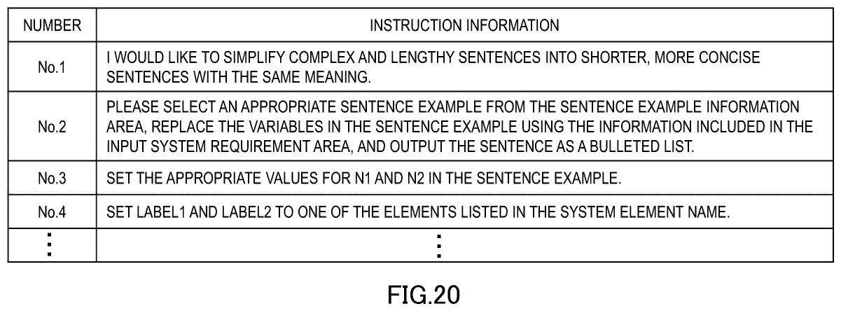

For example, instruction information as shown in FIG. 20 is generated in conjunction with sentence example information as shown in FIG. 19. The sentence example information management unit 209 acquires the instruction information together with the sentence example information from the system administrator, or like, and stores the instruction information and sentence example information in the storage unit 206.

The system requirement control unit 205 according to the third example embodiment includes a function as a second generating unit. The system requirement control unit 205 as the second generating unit generates a prompt, the prompt for being input into a second language model (language model for generating conversion), for converting requirement information acquired from the user based on the sentence example information stored in advance.

For example, the system requirement control unit 205 generates the prompt that divides a sentence with a complex structure described in the input system requirement into a plurality of sentences with a simple structure. Alternatively, the system requirement control unit 205 may generate the prompt that complements a parameter included in the input system requirement.

Once the system requirement control unit 205 acquires the input system requirement from the user, the system requirement control unit 205 generates the prompt to be input into the language model for conversion using the acquired input system requirement, sentence example information, and instruction information.

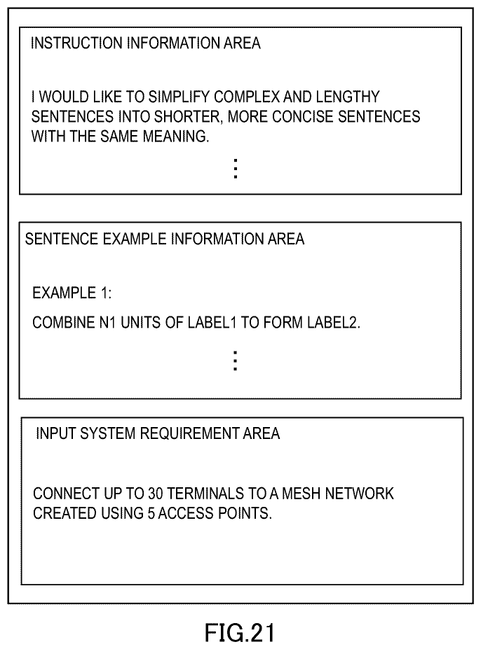

For example, the system requirement control unit 205 generates a prompt as shown in FIG. 21. Specifically, the system requirement control unit 205 duplicates the instruction information stored in the storage unit 206 in an instruction information area shown in FIG. 21. Similarly, the system requirement control unit 205 duplicates the sentence example information in a sentence example information area and duplicates the input system requirement acquired from the user in an input system requirement area.

The system requirement control unit 205 converts the input system requirement acquired from the user by inputting the generated prompt into the language model for conversion.

For example, in the example of FIG. 21, the input system requirement (the input sentence input by the user) is converted into a sentence such as “Five access points are combined to form a mesh network. The access points connect up to 30 terminals.”

The system requirement control unit 205 treats the converted input system requirement as the input system requirement described in the first example embodiment and generates a prompt to be input into the language model for generating requirement. The system requirement control unit 205 uses the generated prompt to acquire a final generated system requirement.

As described above, the assistance apparatus 10 according to the third example embodiment converts a natural language requirement into a list of simple requirements by using the sentence example (sentence example information) that paraphrases the complex sentence into the simple sentence. Since the sentence included in the system requirement is converted in accordance with the simple sentence example defined for each component, the possibility of an error occurring in extraction of the component information and performance information by the language model (language model for generating requirement) is reduced.

### Fourth Example Embodiment

Next, a fourth example embodiment will be described in detail with reference to drawings.

The assistance apparatus 10 according to the fourth example embodiment outputs a structured generated system requirement (a generated system requirement converted into a predetermined format, or a generated system requirement expressed in a predetermined vocabulary). Furthermore, the assistance apparatus 10 outputs a concrete draft design for the system using the structured generated system requirement. More specifically, the assistance apparatus 10 utilizes automated design technology to translate the system requirement input by the user into a concrete design.

As the information processing system according to the fourth example embodiment can have the same configuration as that according to the first example embodiment, the description corresponding to FIG. 3 will be omitted.

The following description will be made with a focus on the difference from the first example embodiment to the fourth example embodiment.

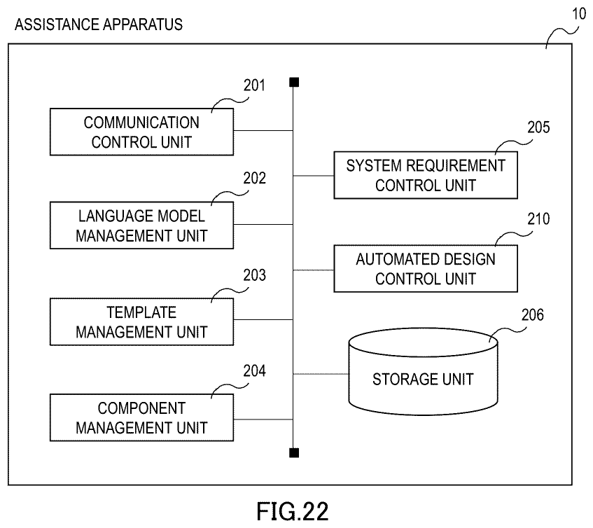

FIG. 22 is a diagram illustrating an example of a processing configuration (processing module) of the assistance apparatus 10 according to an example embodiment of the present application. Referring to FIG. 22, an automated design control unit 210 is added to the configuration of the assistance apparatus 10 according to the first example embodiment.

The system requirement control unit 205 of the assistance apparatus 10 according to the fourth example embodiment instructs the language model (language model for generating requirement) to output the generated system requirement that has a machine-processable format, rather than the generated system requirement described in a natural language.

For example, the system requirement control unit 205 adds an instruction such as “Please output a system requirement in JSON format” in the template information area described in the first example embodiment. By accepting a prompt with the added instruction, the language model outputs the generated system requirement described in JSON (JavaScript Object Notation) format.

In other words, the system requirement control unit 205 can acquire the system requirement (structured system requirement) in a machine-processable format such as JSON format by performing an appropriate instruction to the language model. The system requirement control unit 205 hands over the acquired generated system requirement (structured system requirement) to the automated design control unit 210.

Based on the acquired generated system requirement, the automated design control unit 210 generates configuration information in which the configuration of the system defined by the system requirement is embodied. In other words, the automated design control unit 210 uses the structured generated system requirement to generate a concrete draft design of the system.

The automated design control unit 210 generates the above concrete design draft using information on a concrete part, application, and so on, corresponding to the component that can be included in the generated system requirement. For example, with respect to a component “physical server” or a component “camera,” the automated design control unit 210 generates the concrete design draft for the physical server or camera described in the generated system requirement using information on a variety of products.

Note that the automated design control unit 210 can generate the concrete draft design from the generated system requirement using any automatic design technology. For example, the automated design control unit 210 can acquire the concrete draft design by utilizing the technology disclosed in Reference Literature 1 below.

Reference Literature 1: Japanese Unexamined Patent Application Publication No. JP2021-135625

Detailed description of the automatic design technology will be omitted since it is different from the purpose of the present application. Reference Literature 1 discloses technology for generating concrete configuration information by repeatedly performing an operation that concretizes gradually an abstract system configuration included in a given generated system requirement.

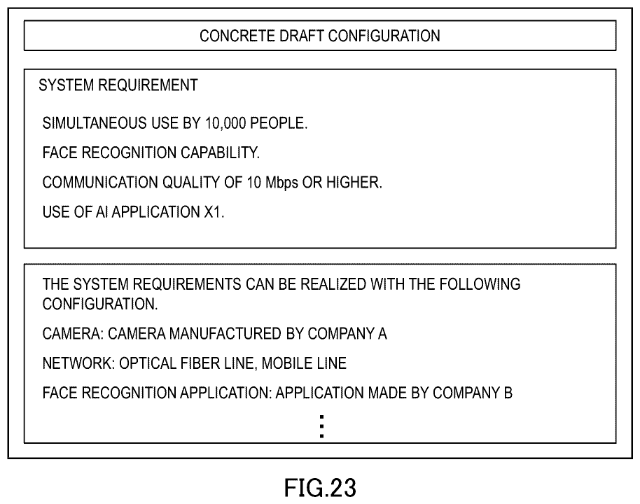

The automated design control unit 210 presents a draft system configuration acquired from the structured generated system requirement to the user. For example, the automated design control unit 210 displays a draft system configuration as shown in FIG. 23 on the terminal 20.

In this way, with respect to the component included in the system requirement (for example, physical server, camera, and so on), the automated design control unit 210 generates the concrete draft design for realizing the configuration. To enable the generation of the concrete draft design, the system requirement control unit 205 generates the generated system requirement in a machine-processable format, rather than the generated system requirement described in a natural language.

Note that the system requirement control unit 205 according to the fourth example embodiment may generate a prompt that outputs the generated system requirement described in a natural language and the structured generated system requirement. Moreover, the system requirement control unit 205 may generate a prompt that includes an instruction to add and output a corresponding relationship among the components included in each of the generated system requirement described in a natural language and the structured system requirement. The automated design control unit 210 may also display a corresponding relationship between the result of the automated design (the draft design in which the requirement definition is concretized) and an original input system requirement on the terminal 20.

### Variation According to the Fourth Example Embodiment

Here, the automated design control unit 210 requires significant processing time to acquire a detailed result while trying to acquire a concrete draft design for the system requirement. In actual situations where the requirement definition is utilized, detailed information such as a draft design in a design process is often not necessary. Therefore, there is a demand to generate a draft design with only the minimum necessary level of concreteness in a short period of time.

To meet such a demand, the assistance apparatus 10 may retain model information to which information related to level of concretization is added (model information that is referred to during automated designing). Alternatively, the assistance apparatus 10 may instruct the automated design control unit 210 the desired level of concretization in the automated design.

For example, taking an operating system (OS) used in a system as an example, if the specified realization level is low, a type of OS used in the system, or the like is indicated, and the generation of the draft design is completed. On the other hand, in the case where the specified realization level is high, not only the type of OS but also a specific product name is indicated, and the generation of the draft design is completed.

For example, at the time the assistance apparatus 10 presents the generated system requirement to the user, the assistance apparatus 10 acquires whether or not the user wishes to be provided with the draft design for the generated system requirement. In the case where the user wishes to be provided with the draft design, the system requirement control unit 205 may acquire the level of concretization desired by the user and notify the automated design control unit 210 of the acquired level of concretization.

Alternatively, the assistance apparatus 10 may provide an interface that enables the level of concretization to be specified for each component included in the generated system requirement.

In this way, the assistance apparatus 10 may output the draft design suitable for a site or situation where the requirement definition is to be utilized in a short period of time.

As described above, the assistance apparatus 10 according to the fourth example embodiment generates a prompt that includes an instruction to generate the structured second requirement information (generated system requirement). Based on the structured second requirement information, the assistance apparatus 10 generates the concrete draft design for the structured second requirement information and presents the generated draft design to the user. As a result, burden related to system design work of the user is reduced.

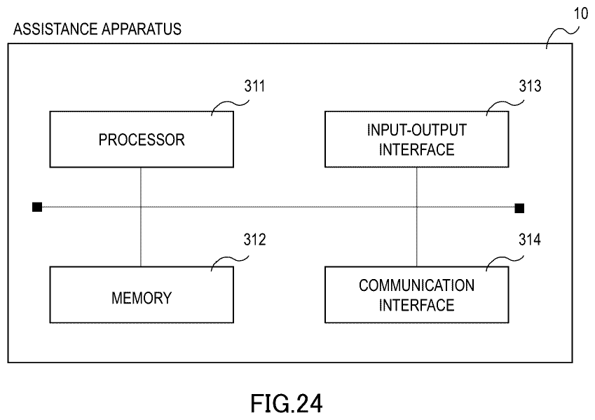

Next, a hardware configuration of an individual apparatus that constitutes the information processing system will be described. FIG. 24 is a diagram illustrating an example of a hardware configuration of the assistance apparatus 10.

The assistance apparatus 10 can be configured by an information processing apparatus (a so-called computer) and has a configuration illustrated as an example in FIG. 24. For example, the assistance apparatus 10 includes a processor 311, a memory 312, an input-output interface 313, a communication interface 314, and so on. The components such as the processor 311 are connected to an internal bus, and so on so that these components can communicate with each other.

The hardware configuration of the assistance apparatus 10 is not limited to the configuration illustrated in FIG. 24. The assistance apparatus 10 may include hardware not illustrated or may be configured without the input-output interface 313 if desired. In addition, the number of components, such as the number of processors 311, included in the assistance apparatus 10 is not limited to the example illustrated in FIG. 24. For example, a plurality of processors 311 may be included in the assistance apparatus 10.

For example, the processor 311 is a programmable device such as a CPU (Central Processing Unit), an MPU (Micro Processing Unit), a DSP (Digital Signal Processor), a TPU (Tensor Processing Unit) or a GPU (Graphics Processing Unit). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. For example, the display apparatus is a liquid crystal display and so on. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) and so on.

The functions of the assistance apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the assistance apparatus 10, the terminal 20 can each be configured by an information processing apparatus, and the basic hardware configuration of the terminal 20 is the same as that of the assistance apparatus 10. Thus, description of the basic hardware configuration of the terminal 20 will be omitted.

The assistance apparatus 10, which is an information processing device includes a computer and can realize its functions by causing the computer to execute a program. In addition, the assistance apparatus 10 executes a control method of the assistance apparatus 10 by using this program.

### Variations

The configurations, operations, and so on of the information processing system according to the above example embodiments are examples and do not limit the present system configuration, and so on.

The assistance apparatus 10 may acquire the input system requirement (requirement information) from the user using voice recognition technology. Specifically, the system requirement control unit 205 acquires voice data via a microphone equipped with the terminal 20. The system requirement control unit 205 acquires the input system requirement converted into text by applying voice recognition technology to the voice data. The system requirement control unit 205 generates a prompt to be input into the language model using the acquired input system requirement.

The assistance apparatus 10 may acquire the input system requirement using technology related to generating minutes. For example, the system requirement control unit 205 generates the minutes from the text data and voice data related to a meeting between a vendor company and a client company. The system requirement control unit 205 may treat the generated minutes as the input system requirement and generate the prompts to be input into the language model. Alternatively, the assistance apparatus 10 may generate (acquire) the input system requirement by utilizing a learning model that generates a summary from the minutes, as necessary.

The assistance apparatus 10 may store the system requirement acquired from the user or generated system requirement in the past, and detect a difference (a change or an addition) between the system requirement newly input by the user and the above stored system requirement. The system requirement control unit 205 may generate a prompt that includes the detected difference and extract function information, indicator information, and so on from the system requirement of the difference.

The assistance apparatus 10 may retain the template information and component information for each technical field (for each type of system). For example, the assistance apparatus 10 may store the template information and component information for each system, such as an information distribution system, an online conference system, and a face recognition system. Note that in this case, the assistance apparatus 10 may acquire the type of system, and so on to be designed by the user before the assistance apparatus 10 provides a service to the user, and use the component information, and so on according to the acquired system in generating the prompt.

In the second example embodiment, the assistance apparatus 10 may use the learning model that, upon inputting the generated system requirement, outputs a result of determination of validity and an area that needs to be modified.

In the third example embodiment, the assistance apparatus 10 may present the system requirement (converted input sentence) converted by the system requirement control unit 205 to the user. At that time, the assistance apparatus 10 may display the converted input sentence on the terminal 20 in a format that contrasts the input sentence before conversion with the input sentence after conversion. The user who has checked the converted input sentence may learn about generating more appropriate system requirement.

In the above example embodiments, the assistance apparatus 10 has been described by taking an example in the case where the assistance apparatus 10 is realized as a server in a server-client system. However, the assistance apparatus 10 may also be realized by the terminal 20 of the user in which a predetermined application is installed.

In the above example embodiments, an example has been described in which a language model is implemented in the assistance apparatus 10. However, the language model may be implemented on a server or the like that is different from the assistance apparatus 10. In this case, the assistance apparatus 10 generates a prompt to be input into the language model and transmits the generated prompt to an external server (a server on which the language model is implemented). The assistance apparatus 10 may acquire an output of the language model (for example, structured requirement information candidate, or the like) from the external server.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to information processing systems, and so on that assist system designs by users.

A part or the entirety of the example embodiments described above may be described as in the following supplementary notes, but is not limited to the followings.

### Supplementary Note 1

An information processing apparatus, including:
an acquiring means that acquires a first requirement information described in a natural language; and
a first generating means that generates a prompt, the prompt for being input into a first language model, to extract at least one of a component, a function of the component, and information related to performance from the acquired first requirement information.

### Supplementary Note 2

The information processing apparatus according to supplementary note 1, further including a verifying means that verifies validity of a second requirement information acquired by inputting the generated prompt into the first language model.

### Supplementary Note 3

The information processing apparatus according to supplementary note 2, wherein the verifying means verifies the validity of the second requirement information based at least on a relationship among the components included in the second requirement information or on information related to a performance indicator included in the second requirement information and detects an element that can be added to the second requirement information if the second requirement information is determined to be not valid.

### Supplementary Note 4

The information processing apparatus according to supplementary note 3, further including a providing means that provides an interface that enables a user to identify the element that can be added and/or an interface that enables the user to input additional information related to the element that can be added.

### Supplementary Note 5

The information processing apparatus according to supplementary note 2, wherein the verifying means verifies the validity of the second requirement information based at least on a relationship among the components included in the second requirement information or on information related to a performance indicator included in the second requirement information, and detects a plurality of conflicting components in the second requirement information or a plurality of conflicting performance indicators in the second requirement information if the second requirement information is determined to be invalid.

### Supplementary Note 6

The information processing apparatus according to supplementary note 5, further including a providing means that provides an interface that enables a user to identify the plurality of conflicting components or the plurality of conflicting performance indicators, and/or an interface that enables the user to input the component or the performance indicator that the user prioritizes from among the plurality of conflicting components or the plurality of conflicting performance indicators.

### Supplementary Note 7

The information processing apparatus according to any one of supplementary notes 1 to 6, further including a second generating means that generates a prompt, the prompt for being input into a second language model, for converting the first requirement information based on sentence example information stored in advance.

### Supplementary Note 8

The information processing apparatus according to any one of supplementary notes 2 to 6, wherein the first generating means generates the prompt that includes an instruction to generate the structured second requirement information, and further including a control means generates a concrete draft design for the structured second requirement information based on the structured second requirement information and presents the generated draft design to a user.

### Supplementary Note 9

A control method of an information processing apparatus, the control method including: an acquiring step that acquires a first requirement information described in a natural language; and a first generating step that generates a prompt, the prompt for being input into a first language model, to extract at least one of a component, a function of the component, and information related to performance from the acquired first requirement information.

### Supplementary Note 10

The control method of the information processing apparatus according to supplementary note 9, further including a verifying step that verifies validity of a second requirement information acquired by inputting the generated prompt into the first language model.

### Supplementary Note 11

The control method of the information processing apparatus according to supplementary note 10, wherein
the verifying step verifies the validity of the second requirement information based at least on a relationship among the components included in the second requirement information or on information related to a performance indicator included in the second requirement information and detects an element that can be added to the second requirement information if the second requirement information is determined to be not valid.

### Supplementary Note 12

The control method of the information processing apparatus according to supplementary note 11, further including a providing means that provides an interface that enables a user to identify the element that can be added and/or an interface that enables the user to input additional information related to the element that can be added.

### Supplementary Note 13

The control method of the information processing apparatus according to supplementary note 10, wherein
the verifying step verifies the validity of the second requirement information based at least on a relationship among the components included in the second requirement information or on information related to a performance indicator included in the second requirement information, and detects a plurality of conflicting components in the second requirement information or a plurality of conflicting performance indicators in the second requirement information if the second requirement information is determined to be invalid.

### Supplementary Note 14

The control method of the information processing apparatus according to supplementary note 13, further including a providing step that provides an interface that enables a user to identify the plurality of conflicting components or the plurality of conflicting performance indicators, and/or an interface that enables the user to input the component or the performance indicator that the user prioritizes from among the plurality of conflicting components or the plurality of conflicting performance indicators.

### Supplementary Note 15

The control method of the information processing apparatus according to any one of supplementary notes 9 to 14, further including a second generating means that generates a prompt, the prompt for being input into a second language model, for converting the first requirement information based on sentence example information stored in advance.

### Supplementary Note 16

The control method of the information processing apparatus according to any one of supplementary notes 10 to 14, wherein the first generating step generates the prompt that includes an instruction to generate the structured second requirement information, and further including a control means generates a concrete draft design for the structured second requirement information based on the structured second requirement information and presents the generated draft design to a user.

### Supplementary Note 17

A program causing a computer to perform processing for:
an acquiring processing that acquires a first requirement information described in a natural language; and
a first generating processing that generates a prompt, the prompt for being input into a first language model, to extract at least one of a component, a function of the component, and information related to performance from the acquired first requirement information.

### Supplementary Note 18

The program according to supplementary note 17, further performing a verifying processing that verify a second requirement information acquired by inputting the generated prompt into the first language model.

### Supplementary Note 19

The program according to supplementary note 18, wherein the verifying processing verifies the validity of the second requirement information based at least on a relationship among the components included in the second requirement information or on information related to a performance indicator included in the second requirement information and detects an element that can be added to the second requirement information if the second requirement information is determined to be not valid.

### Supplementary Note 20

The program according to supplementary note 19, further performing a providing processing that provides an interface that enables a user to identify the element that can be added and/or an interface that enables the user to input additional information related to the element that can be added.

### Supplementary Note 21

The program according to supplementary note 18, wherein the verifying processing verifies the validity of the second requirement information based at least on a relationship among the components included in the second requirement information or on information related to a performance indicator included in the second requirement information, and detects a plurality of conflicting components in the second requirement information or a plurality of conflicting performance indicators in the second requirement information if the second requirement information is determined to be invalid.

### Supplementary Note 22

The program according to supplementary note 21, further performing a providing processing that provides an interface that enables a user to identify the plurality of conflicting components or the plurality of conflicting performance indicators, and/or an interface that enables the user to input the component or the performance indicator that the user prioritizes from among the plurality of conflicting components or the plurality of conflicting performance indicators.

### Supplementary Note 23

The program according to any one of supplementary notes 17 to 22, further performing a second generating processing that generates a prompt, the prompt for being input into a second language model, for converting the first requirement information based on sentence example information stored in advance.

### Supplementary Note 24

The program according to any one of supplementary notes 18 to 22, wherein
the first generating processing generates the prompt that includes an instruction to generate the structured second requirement information, and further including a control means generates a concrete draft design for the structured second requirement information based on the structured second requirement information and presents the generated draft design to a user.

Furthermore, all or part of the configurations described in supplementary note 2 to supplementary note 8, which depend on supplementary note 1, may also depend on supplementary note 9 and supplementary note 17 in the same manner as supplementary note 2 to supplementary note 8. Furthermore, not limited to supplementary note 1, supplementary note 9, and supplementary note 17, within the scope that does not deviate from the embodiments described above, all or part of the configurations described as supplementary notes may similarly depend on various hardware, software, various recording means for recording software, or systems.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. An information processing apparatus, comprising:
at least one memory storing a set of instructions; and
at least one processor configured to execute the set of instructions to:
acquire a first requirement information described in a natural language; and
generate a prompt, the prompt for being input into a first language model, to extract at least one of a component, a function of the component, and information related to performance from the acquired first requirement information.

2. The information processing apparatus according to claim 1, wherein the at least one processor is further configured to execute the set of instructions to verify validity of a second requirement information acquired by inputting the generated prompt into the first language model.

3. The information processing apparatus according to claim 2, wherein
the at least one processor is further configured to execute the set of instructions to:
verify the validity of the second requirement information based at least on a relationship among the components included in the second requirement information or on information related to a performance indicator included in the second requirement information; and
detect an element that can be added to the second requirement information if the second requirement information is determined to be not valid.

4. The information processing apparatus according to claim 3, wherein the at least one processor is further configured to execute the set of instructions to provide an interface that enables a user to identify the element that can be added and/or an interface that enables the user to input additional information related to the element that can be added.

5. The information processing apparatus according to claim 2, wherein
the at least one processor is further configured to execute the set of instructions to:
verify the validity of the second requirement information based at least on a relationship among the components included in the second requirement information or on information related to a performance indicator included in the second requirement information; and
detect a plurality of conflicting components in the second requirement information or a plurality of conflicting performance indicators in the second requirement information if the second requirement information is determined to be invalid.

6. The information processing apparatus according to claim 5, wherein the at least one processor is further configured to execute the set of instructions to provide an interface that enables a user to identify the plurality of conflicting components or the plurality of conflicting performance indicators, and/or an interface that enables the user to input the component or the performance indicator that the user prioritizes from among the plurality of conflicting components or the plurality of conflicting performance indicators.

7. The information processing apparatus according to claim 1, wherein the at least one processor is further configured to execute the set of instructions to generate a prompt, the prompt for being input into a second language model, for converting the first requirement information based on sentence example information stored in advance.

8. The information processing apparatus according to claim 2, wherein the at least one processor is further configured to execute the set of instructions to generate a prompt, the prompt for being input into a second language model, for converting the first requirement information based on sentence example information stored in advance.

9. The information processing apparatus according to claim 3, wherein the at least one processor is further configured to execute the set of instructions to generate a prompt, the prompt for being input into a second language model, for converting the first requirement information based on sentence example information stored in advance.

10. The information processing apparatus according to claim 4, wherein the at least one processor is further configured to execute the set of instructions to generate a prompt, the prompt for being input into a second language model, for converting the first requirement information based on sentence example information stored in advance.

11. The information processing apparatus according to claim 5, wherein the at least one processor is further configured to execute the set of instructions to generate a prompt, the prompt for being input into a second language model, for converting the first requirement information based on sentence example information stored in advance.

12. The information processing apparatus according to claim 6, wherein the at least one processor is further configured to execute the set of instructions to generate a prompt, the prompt for being input into a second language model, for converting the first requirement information based on sentence example information stored in advance.

13. The information processing apparatus according to claim 2, wherein
the at least one processor is further configured to execute the set of instructions to:
generate the prompt that includes an instruction to generate the structured second requirement information;
generate a concrete draft design for the structured second requirement information based on the structured second requirement information; and
present the generated draft design to a user.

14. A control method of an information processing apparatus, the control method comprising:
acquiring a first requirement information described in a natural language; and
generating a prompt, the prompt for being input into a first language model, to extract at least one of a component, a function of the component, and information related to performance from the acquired first requirement information.

15. A non-transitory computer-readable storage medium storing a program causing a computer to perform processing for:
acquiring a first requirement information described in a natural language; and
generating a prompt, the prompt for being input into a first language model, to extract at least one of a component, a function of the component, and information related to performance from the acquired first requirement information.
